(19) United States
(12) Patent Application Publication
(10) Pub. No.: US 2005/0267894 A1
(43) Pub. Date: Dec. 1, 2005

(54) XML metabase for the organization and manipulation of digital media

(75) Inventor: Shawn Camahan, Nevada City, CA (US)

Correspondence Address: DLA PIPER RUDNICK GRAY CARY US, LLP, 2000 UNIVERSITY AVENUE, E. PALO ALTO, CA, 94303-2248, US

(73) Assignee: Telestream, Inc.

(21) Appl. No.: 11/142,047

(22) Filed: May 31, 2005

Related U.S. Application Data
(60) Provisional application No. 60/575,934, filed on Jun. 1, 2004.
(60) Provisional application No. 60/575,935, filed on Jun. 1, 2004.
(60) Provisional application No. 60/575,936, filed on Jun. 1, 2004.

(51) Int. Cl. G06F 7/00

(52) U.S. Cl. 707/10

(57) ABSTRACT

Described is the architecture and implementation of a metabase specifically designed for the organization, management and manipulation of digital media assets. In this context the term digital media refers to a sequence of digitally encoded video and/or audio samples. The metabase is a collection of node objects which can be implemented as XML elements and organized in a tree-like or hierarchical structure that emanates from a single root node, and stored in disk drive storage or internal cache storage as discussed subsequently. Two node objects used to form this structure are the folder and the binder.

### RELATED APPLICATIONS

Priority is claimed to Provisional Application Ser. Nos. 60/575,934 filed on Jun. 1, 2004, 60/575,935 filed on Jun. 1, 2004 and 60/575,936 filed on Jun. 1, 2004, each incorporated herein by reference.

### BACKGROUND OF THE INVENTION

This patent relates to the architecture and implementation of a metabase specifically designed for the organization, management and manipulation of digital media assets. In this context the term digital media refers to a sequence of digitally encoded video and/or audio samples.

### BRIEF DESCRIPTION OF THE DRAWINGS

FIG. 1A is a diagrammatic illustration of the syntax term.

FIG. 1B is a diagrammatic illustration of the stream term.

FIG. 1C is a diagrammatic illustration of the codec term.

FIG. 1D is a diagrammatic illustration of the container term.

FIG. 1E is a diagrammatic illustration of the media term.

FIG. 1F is a diagrammatic illustration of the decoder term.

FIG. 1G is a diagrammatic illustration of the encoder term.

FIG. 1H is a diagrammatic illustration of the transport term.

FIG. 2 illustrates a collection of node objects.

FIG. 3. illustrates the implementation of the XML metabase of the invention as an operating system service.

FIG. 4 illustrates the XML metabase of the invention as a collection of folders.

### DESCRIPTION

Data Sets

A media asset consists of two primary datasets; the media essence and the metadata that describes that essence.

The essence takes the form of one or more digital media files which typically range in size from several megabytes to several terabytes. The essence typically consists of multiple renditions of the media asset, each representing a translation of the original asset using a different file format, location or quality.

Metadata takes the form of text, images and documents that describe the media asset. Metadata may be objective; information that is extracted directly from the essence, or subjective; information that is provided by a user based on their perception of the media. Metadata is typically very small in comparison to the size of the associated media essence.

Data Locality

A rendition of the media essence is typically created for use by a particular system, device or distribution mechanism. For example, it might be a requirement to distribute a media asset via satellite television, from a video-on-demand server and over the Internet.

Each distribution system requires a different rendition of the media essence specific to that system. Furthermore, each rendition should physically reside at a storage location specific to the associated delivery system.

The spatial locality of the rendition may be dictated by network bandwidth, file system limitations or security requirements. In any case, the essence data is inherently distributed across multiple devices and storage systems within the application domain.

Conversely, the metadata describing the media essence and the location of each rendition is stored within a single metabase within the domain.

Vocabulary

A structured vocabulary is used to identify, exchange and manage digital media. In this context digital media is defined as a file or data stream containing multiple video, audio and metadata essence streams where each essence stream may be in a variety of compressed or uncompressed representations.

A vocabulary is a collection of terms used, and understood, by all applications within a specific application domain. Each term symbolizes and communicates a meaning about a specific object, process or capability within the domain.

A structured vocabulary defines both the terms and the context or hierarchy in which those terms may be used.

Within a digital media domain, communication is achieved by transporting documents, written in this vocabulary, between multiple applications. The mechanism used to transport the document between applications (file, network protocol, and the like) is independent of the vocabulary.

Similarly, the document containing the lexicon could be in a variety of formats; however, a preferred implementation would use extensible Markup Language (XML) since it provides a means to express both the terms of the vocabulary and the hierarchical structure.

The vocabulary described here is specific to the exchange of essence streams within the digital media domain. By nature, applications within this domain (creation, production, distribution, archive, and the like) have different requirements for the format or representation of the essence streams. While the concepts are applicable to other domains and essence samples (graphics, text, and the like), the wide variety of formats employed within this domain presents a more significant challenge to the exchange process.

Attributes & Parameters

Each term within the vocabulary may have one or more defined attributes that further clarify the meaning of that term. An attribute consists of both a name and a value. Like a term, an attribute (and its value) must be understood by any application using the vocabulary.

A term may also contain one or more parameters. Like an attribute, a parameter consists of a name and value, however an application is not required to understand the meaning of a parameter or interpret its value.

An attribute is always applicable to the term that it helps clarify. Furthermore, an attribute always has the same meaning regardless of the term to which it is applied. In contrast, while a parameter always has the same meaning it may only be applicable to a term under certain conditions or within a specific application.

As an example of the differences between attributes and parameters consider a vocabulary that defined the term person. This vocabulary might also define a country attribute that contains the person's country of residence as its value. A social-security parameter would only be applicable to the person if they lived in the United States.

Syntax

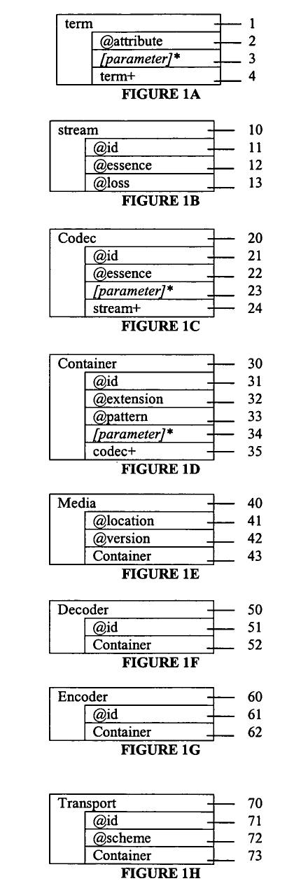

A term is illustrated diagrammatically in FIG. 1A. The name of each required attribute 2 of a term 1 is prefixed with a ‘@’ symbol. Allowable parameters 3 are surrounded by square braces ‘[]’. The terms 4 that are allowed in the context of the term being defined are listed at the bottom of the diagram.

Additionally, each child term or parameter may be suffixed by a single character which indicates the permissible usage of the term or parameter. The absence of this character indicates the usage of the term or parameter is required and singular.
+ Indicates the term is required but may occur more than once (plural).
? Indicates the term or parameter is optional but if present may occur only once (singular).
* Indicates the term is optional and may occur more than once (plural)
   Identification

This portion of the vocabulary defines the terms that are used to classify or identify the format of existing media and control the creation of new media.

Stream

A stream is illustrated in FIG. 1B symbolizes a sequence of essence samples. A stream 10 can represent a sequence of video frames, audio samples, metadata samples or a combination of these types. The samples within the stream may be in a compressed (MPEG, DV, JPEG, and the like) or uncompressed (RGB, YUV, PCM, and the like) representation.

The id 11 attribute identifies the format of the stream. The value of the id attribute must be unique among all known stream formats. The essence 12 attribute defines the type of samples (video, audio, etc.) contained within the stream 10.

The loss attribute 13 contains a numeric value that indicates the amount of information that is lost when essence samples are represented by the stream format. The value is relative to the context in which the stream term is used (usually a codec).

Codec

A codec is illustrated diagrammatically in FIG. 1C. The term codec describes an algorithm used to convert a sample stream from one format to another. Dolby® AC3 and ISO13818-X (MPEG-2 Video) are examples of codec algorithms. In most cases a codec 20 describes an algorithm that reduces the amount of data required to represent the essence samples within a stream. However, this is not a requisite of the definition, a codec may simply change the representation (e.g. from RGB to YUV color space) without reducing the amount of information. The term codec implies a symmetrical or bidirectional process. The exact direction (encode or decode) depends on the context in which the term is used.

The id attribute 21 identifies the stream format produced (during encoding) or consumed (during decoding) by the algorithm. The value of the id attribute must be one of the stream identifiers described above.

The essence attribute 22 determines the type of essence samples that can be processed by the algorithm.

Parameters 23 of FIG. 1C are used to describe the results of, or control the operation of the codec algorithm. Video frame size, compressed bit rates and audio sampling frequency are examples of Parameters typically defined by a codec.

A codec is further described by one or more stream terms 24. These define the stream formats that the codec is capable of producing (during decoding) or consuming (during encoding).

Container

The term container describes a digital media format and is illustrated diagrammatically in FIG. 1D. Specifically, it symbolizes a procedure that is used to encapsulate or multiplex one or more essence streams into a single file or data stream. The ISO11172-X (MPEG-1) and ISO13818-X (MPEG-2 Systems) standards are examples of container formats.

The id attribute 31 identifies the container 30 format. The value of the id attribute must be unique among all known container formats.

The extension 32 attribute contains a list of generally accepted extensions (.mpg, .mov, etc.) applied to files that use the container format.

Container formats typically use a regular and identifiable sequence of bytes to delineate the samples or packets within the media data. The pattern attribute 33 contains a list of pattern specifications that can be used to positively identify a container by examining the data within a file or stream.

Parameters 34 of FIG. 1D are used to describe the results of, or control the behavior of, the multiplexing or encapsulation process.

A container is further described by one or more codec terms 35. These terms define the stream formats that are allowed within the container format. For example, the ISO13818-X (MPEG2 Systems) standard permits the following essence streams:
MPEG1, MPEG2 & MPEG4 video
MPEG1 Layer 1,2 & 3, MPEG2, AC3 and PCM audio
   Media

The term media, illustrated in FIG. 1E, symbolizes a digital media file or data stream at a specific location. The term media 40 may refer to an existing file, or to a file that will be created.

The location attribute 41 indicates the location of the media using the Uniform Resource Locator (URL) syntax described in RFC1738:
scheme://user@host:port/path/name.ext

Exchanging media from one application to another may require that the format of the essence streams be changed. A single exchange results in two instances of the media each containing the same essence samples but in different stream formats. Under certain conditions, changing the format of the samples may result in a loss of information or quality.

The version attribute 41 contains a numeric value that indicates the generation or quality of the media with respect to any other instance. The instance with the lowest version number is always the highest quality.

Exchange

This portion of the vocabulary defines the terms that are used to negotiate and execute a media transfer from one location to another.

Decoder

The term decoder symbolizes a component within the domain that is capable of decoding a specific media container format and is illustrated diagrammatically in FIG. 1F.

The id attribute 51 must uniquely identify the decoder 50 among all other components within the domain.

The decoding process is as follows:
The decoder 50 extracts the individual essence streams 12 from the media 40 based on the procedure implied by the container term.
For each essence stream 12 the decoder 50 applies the algorithm implied by the corresponding codec term.
Each codec 20 produces a sample stream in a format implied by the corresponding stream term.
   Encoder

The term encoder symbolizes a component within the domain that is capable of encoding a specific media container format and is illustrated diagrammatically in FIG. 1G.

The id attribute 61 must uniquely identify the encoder among all other components within the domain.

The encoding process is as follows:
The encoder 60 accepts one or more sample streams 12; the format of each stream is determined by a stream term.
For each stream the encoder 60 applies the algorithm implied by the corresponding codec context term.
The streams produced by each codec are then multiplexed into the media using the procedure implied by the container context term.
   Transport

The term transport symbolizes a component within the domain that is capable of moving media data between a specific location and another component and is illustrated diagrammatically in FIG. 1H and is seen illustratively at 70. The component that is consuming or producing the media data could be a decoder, an encoder or another transport.

The id attribute 71 must uniquely identify the transport among all other components within the domain.

The scheme attribute 72 indicates the protocol or communications mechanism (e.g. FTP, HTTP, etc.) that the transport component 70 implements. Simply stated, the component provides transport to or from any location with the same scheme.

### Logical Structure

The metabase comprises objects that fall into one of three categories: organization, behavior (or rules) and content. These can be appropriately stored in system storage.

Organizational Objects

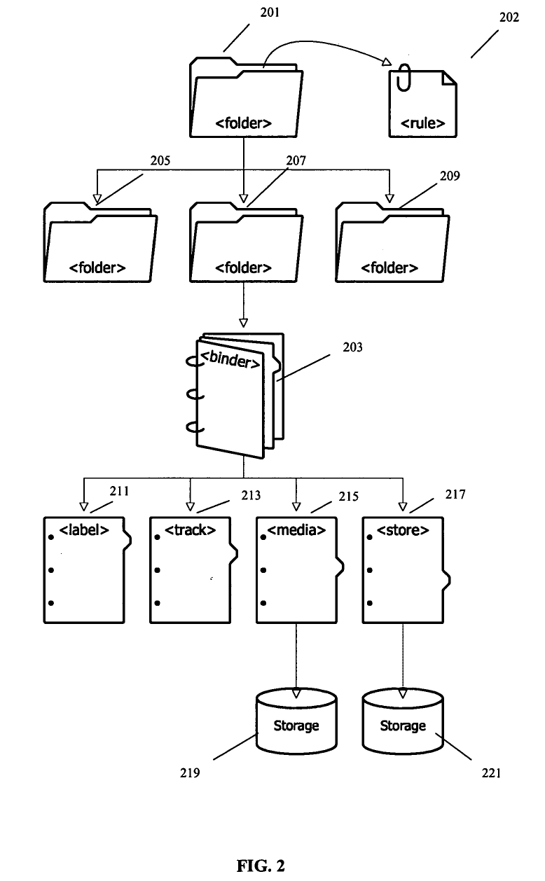

The metabase is a collection of node objects which can be implemented as XML elements and organized in a tree-like or hierarchical structure that emanates from a single root node, and stored in disk drive storage or internal cache storage as discussed subsequently. This collection of node objects is illustrated diagrammatically in FIG. 2. Two node objects are used to form this structure: the folder such as parent folder 201 and the binder 203.

Folder

A folder represents a generic container. Each folder 201 may contain child folders 205, 207, 209 allowing the metabase to be organized in a hierarchy similar to a conventional file system.

Each folder 201 has a name which must be unique within the scope of the immediate parent folder. The location of a folder 201 is described by its fully qualified path within the hierarchy, for example:
/Live/MSNBC
   Binder

A folder such as that illustrated at 207 may also contain one or more binders 203. A binder represents a media asset within the metabase and “binds” together all of the metadata related to that asset.

Like a folder, each binder has a unique name within the scope of its parent folder. However, a binder may not contain folders or other binders. The location of a binder is described by its fully qualified path within the hierarchy, for example:
/Live/MSNBC/Evening News
   Content Objects

A binder contains one or more content objects each describing a different aspect (metadata and essence as described above) of the media asset. Each content object has a name which must be unique within the scope of the parent binder 203. The location of a content object is described by its fully qualified path within the hierarchy, for example:
/Live/MSBNC/Evening News/Original.mpg

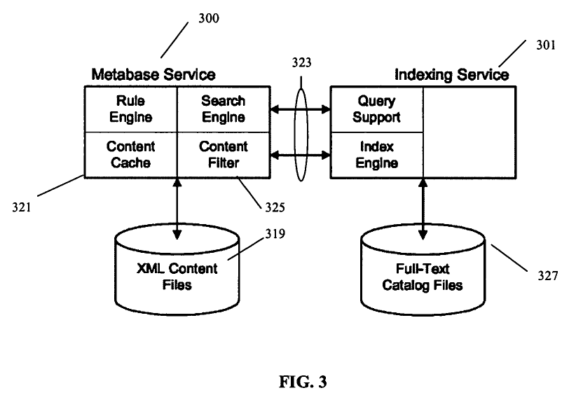

Four types of content objects may be contained within a binder: label 211, track 213, media 215 and store 217. The purpose of the label and track is to be operated on by a content filter and a search engine as discussed with respect to FIG. 3, subsequently.

Label

A label object 211 contains structured metadata that describes the entire media asset such as the title, rating, author, etc. The purpose of this object is analogous to a label that would be affixed to a videocassette or videodisc. That is, a label is a collection of parameters that define a template or schema. Each parameter has a name, a value and constraints that restrict the options or range of the value. A label is designed based on the requirements of the application or the type of media assets that are being described. An instance of the label is added to a binder and then populated with metadata extracted from the media asset or provided by a user.

When a label is designed it is assigned an identifier which uniquely defines the collection and purpose of the schema. A binder may contain multiple labels but may only contain a single instance of a specific label schema.

Track

A track object 213 contains structured metadata that occur at specific points or during specific intervals within the media asset such as closed captions, key frames, or speech-to-text extraction.

A track is a collection of time segments; each segment has a value and a time stamp that determines when the value occurs within the media. A segment may contain any type of data (text, number, image, etc.) however, within a specific track all segments must contain the same value type.

Track schemas are defined based on the type of information they contain and the source of that information. For example, speech-to-text and closed captions are considered different tracks even though they both contain textual, and possibly similar, information.

Each track schema is assigned a unique identifier. A binder may contain multiple tracks but may only contain a single instance of a specific track schema.

Media

A media object 215 represents a specific rendition of the media essence. This object contains structured metadata that describes the following:
The current location of the stored media file 219 that contains the video and audio samples for this version of the essence.
The format of the media file; the algorithms and parameters used to encode the individual video and audio sample streams and the mechanism used to combine the streams into a single data file. This information precisely resolves the compatibility of the media version with a specific device or system.

The media object owns the associated media file, regardless of the location of that media file. If the media object is deleted or otherwise rendered unused, so is the associated media file.

Store

A store object 217 represents unstructured data that is associated with the media asset 215 that does not fall into the categories of data to be included in a label 211, track 213, or media 215. A store typically contains the data produced by other applications such as spreadsheets, word processing documents or graphics. The data contained within the store is only meaningful to the application that created the data or an application that recognizes the document type. The data may be stored internally within the metabase such as in content cache 321, or in an external file such as at 221. In either case the store object owns the associated data; if the store is deleted from the database so is the associated data.

Behavioral Objects

A rule 202 is an object which is applied to a node such as folder 201 or binder 203 and governs the behavior of that node during its lifetime. If a rule is not explicitly attached to a node, the node inherits the rule from its nearest ancestor. Rules fall into several categories, an inexhaustive group of which is seen below:

Access

The access rule determines the permissions granted to a user or group of users. The permissions allow that user or group to read, write, or delete the associated node or to change the permissions granted to other users.

Schema

The schema rule determines the label and track metadata templates that are automatically added to a binder. This rule is typically applied to a folder. When a binder is created within that folder, an instance of each metadata schema is added to the binder. A schema containing objective metadata is populated automatically by extracting the appropriate information from the media essence, discussed previously. Subjective metadata schemas are populated manually by a user based on their perception of the media. This can be done by keyboard entry into the metabase, or by entry into some other application and then into the metabase as a label.

Renditions

The rendition rule determines the additional versions of the media essence that are required by other systems, applications or devices within the domain.

Each rendition is created by translating the original media essence, defined above, to a new file using a different file format and encoding parameters. The file location and format metadata are then added to the binder in the form of a media object.

A version may be created automatically when the associated binder is created, or on demand from another application or device. A version may be stored at a specific location or within a pool of storage that has been allocated for use by the metabase.

Storage

The storage rule assigns pools, or depots, of physical storage space to specific folder. When a new rendition of a media asset is created, the storage space required for the media file is allocated from one of the available depots. Each depot defines the physical location of the storage, the available storage space and the methods that may be used to access the storage space. For example, media files contained in a disk folder (e.g. C:\MyFolder) might also be accessible through FTP or HTTP network protocols.

Storage depots may be added or removed from a metabase folder as the storage configuration of the domain changes.

Expiration

The expiration rule controls how long a media asset remains within the domain and the disposition of each rendition when that asset expires. This duration is created by the user based on the application or on the media type. For example, it the application is incoming news for a television broadcast, the duration may be only one day inasmuch as news loses its value as news after a certain length of time, for example a day.

If and when a binder 203 reaches its expiration date, the media objects within the binder are examined. The disposition of the object determines if the associated media file is:
Permanently deleted. The media object is removed from the binder.
Moved to an archive device such as a tape library, CD or DVD. The media object is modified to indicate the new location of the media file within the archive.
Retained indefinitely.

Following the disposition of the renditions, if all of the media objects have been removed the binder is removed from the metabase.

### Physical Structure

The metabase has a physical structure and implementation. The metabase is implemented as an operating system service, seen generally in FIG. 3, that may be accessed using one or more network protocols or programming interfaces. The information contained within the metabase is stored using extensible Markup Language (XML) and manipulated using standard XML processors and techniques.

Organizational Elements

Objects that form the organizational structure of the metabase can be contained within a single XML directory document. Each folder 201 and binder 203 object of FIG. 1 is represented by a corresponding XML element. The hierarchical organization of the metabase is reflected by the nesting of these elements as shown below:

<?xml version=“1.0” encoding=“UTF-8”?>
<folder name=“Live”>

<folder name=“MSNBC”>

<binder name=“Evening News”
uuid“{00000000-0000-0000-0000-000000000000}”/>

</folder>

</folder>

Each node element has a name attribute, shown above, which must be unique within the parent element. The location of a node is then uniquely identified by its path within the metabase, for example:
/Live/MSNBC/Evening News

The path may be expanded to the equivalent XPath notation as:
/folder[@name=‘Live’]/folder[@name=‘MSNBC’]/binder[@name=‘Evening News’]

Each binder within the metabase is also assigned a Universally Unique Identifier (UUID). A UUID is a large (typically 128 bit) integer which, due to its precision, has a very low probability of being duplicated.

Content Elements

The objects that represent the metadata content of a specific binder 203 are contained within a separate XML content document. The content document is correlated to the directory document through the UUID of the associated binder.

Each content object (label 211, track 213, media 215 or store 217) is represented by a corresponding XML element as shown below:

<?xml version=“1.0” encoding=“UTF-8”?>
<content uuid=“{00000000-0000-0000-0000-000000000000}”>

<label name=“MyLabel.xml”
uuid“{11111111-1111-1111-1111-111111111111}”/>
<track name=“Captions.xml”
uuid=“{22222222-2222-2222-2222-222222222222}”/>
<media name=“Original.mpg” version=“0.0.0”/>
<store name=“Script.doc” position=“External”/>
<store name=“Desktop.ini” position=“Internal”/>

</content>

Label Element

A label, seen previously at 211 in FIG. 2, is a collection of child parameter elements that form a template or schema. Each schema is assigned a UUID which uniquely identifies the nature of the information contained in the label. A content document may contain multiple label elements but only a single instance of a specific label schema. This prevents the metabase from containing conflicting information about the media asset. An example of a label is seen below.

<labelname=“MyLabel.xml”
uuid=“{11111111-1111-1111-1111-111111111111}”>

<parameter name=“Genre” type=“String”>Sports

<default>News</default>
<option>Series</option>
<option>Sports</option>

</parameter>
<parameter name=“Channel” type=“Integer”>119

<minimum>1</minimum>
<maximum>999</maximum>

</parameter>

</label>

Each parameter has a name, which must be unique within the schema, and a type that determines how the value of the parameter is interpreted.

A parameter may also contain child elements that constrain the range of the value or the set of allowable values. Parametric constraints are crucial to data entry and subsequent searching of the metabase.

Track Element

A track, seen previously at 213 of FIG. 1.2, is a collection of child segment elements that occur at specific times or during specific intervals within the media asset. Each track schema is assigned a UUID that uniquely identifies both the nature and source of the information contained in the track.

A content document may contain multiple track elements but only a single instance of a specific track schema. This prevents the metabase from containing conflicting information about the media asset. An example of a track is seen below.

<track name=“Captions.xml”
uuid=“{22222222-2222-2222-2222-222222222222}” content-
type=“text/plain”>

<parameter name=“Line” type=“Integer”>21

<minimum>10</minimum>
<maximum>22</maximum>
<default>21</default>

</parameter>
<segment time=“00:00:10.000”
type=“String”>Jim: WE WELCOME YOU BACK TO

MSNBC.</segment>

<segment time=“00:00:20.000” type=“String”>Bob:
IN TONIGHT'S TOP STORY THE</segment>

</track>

Each segment has a time of occurrence and, optionally, a duration. The segment time is relative to the beginning of the media asset and must be unique within the parent track. The segment type determines how the value of the segment should be interpreted.

A track may also contain child parameter elements that control the process of extracting the segment information from the media asset.

Media Element

A media element, previously seen at 215 in FIG. 2, describes a specific rendition of the media essence. Each media element within the parent content has both a location and a version attribute.

The location attribute indicates the physical location of the associated media file using the Uniform Resource Locator (URL) syntax defined by RFC1738. The version attribute contains a numeric value that indicates the generation or quality of the rendition with respect to any other instance. The instance with the lowest version number is always the highest quality. An example of media is seen below.

<media name=“Original.mpg”
version=“0.0.0” location=“file://C:/Media/Original.mpg”>

<container name=“MPEG2 Program Stream”
extension=“mpg mpeg mp2”>

<codec name=“ISO13818 MPEG2” essence=“video”>

<parameter name=“Width”
type=“Integer”>720</parameter>

</codec>
<codec name=“ISO11172 MPEG Layer 2” essence=“audio”>

<parameter name=“Channels”
type=“Integer”>2</parameter>

</codec>

</container>

</media>

A media element also contains child elements that describe the format of the rendition. The container element, a child of the media element, defines the mechanism used to encapsulate or multiplex one or more essence streams into a single digital media file. The format is further specified by child codec elements that describe the individual video and audio essence streams.

Store Element

A store element, previously seen at 217 in FIG. 1, contains, or references, unstructured data related to the media asset. A store typically contains the data produced by other applications such as spreadsheets, word processing documents or graphics. Each store element has a position attribute that determines whether the data stored internally or within an external file.

An external store, 221 of FIG. 2, has a location attribute that indicates the physical location of the file containing the data.

<store name=“Script.doc” position=“External”
location=“file://MyServer/MyDocuments/Script.doc”/>

An internal store contains the data directly, for example as a Base64 encoded string. Typically, external storage is used to store elements with large amounts of data which in internal store is used to store elements having a very small amount of data.

<store name=“Desktop.ini” position=“Internal”>
Wy5TaGVsbENsYXNzSW5mb10NCkNvbmZpcm1
GaWxIT3A9MA0KTm9TaGFyaW5nPTENCkljb25GaW
xl PUJpbmRlci5pY28NCkljb25JbmRleD0wDQp
JbmZvVGIwPU1lZGlhIEJpbmRlcg0K
</store>

Behavioral Elements

A folder, 201 or 207, may contain child elements that define the rules or behavior of the folder. If a folder (or a binder 203) of FIG. 1 does not contain a specific rule 202, it inherits that rule from the nearest ancestor where the rule is specified. In the example below binder ‘Evening News’inherits its rules from folder ‘Live’.

<?xml version“1.0” encoding“UTF-8”?>
<folder name=“Live”>

<folder name=“MSBNC”>

<binder name=“Evening News”
uuid=“{00000000-0000-0000-0000-000000000000}”/>

</folder>
<access>

<permission role=“Everyone”>Read
Write Delete Change</permission>

</access>
<render>

<version name=“Original” version=“0.0.0” archive=“true”/>
<version name=“Proxy” version=“1.0.0” sustain=“true”>

<encoder/>

</version>

</render>
<schema>

<label name=“MyLabel”
uuid=“{11111111-1111-1111-1111-111111111111}”/>
<track name=“Captions”
uuid=“{22222222-2222-2222-2222-222222222222}”/>

</schema>
<storage>

<depot location=“file://C:/Media”/>

</storage>
<expire duration=“30”/>

</folder>

### Implementation

The metabase is implemented as an operating system service, seen generally in FIG. 3, that may be accessed using one or more network protocols or programming interfaces. The service consists of four major components. The rule engine is responsible for executing the rules defined on each folder and binder in the metabase. The content cache ensures that frequently accessed binders are available directly from memory thereby increasing the access speed. The content filter extracts meaningful text from each XML content document and provides that text to an external indexing service. The search engine accepts and executes search requests from client applications. Depending on the type of search requested, the engine may execute the search directly or refer the request to the external indexing service.

Caching & Concurrency

Turning now to FIG. 3, the metabase directory and individual content documents are stored as XML files in storage 319. When the metabase service is started the directory XML file is parsed and the resulting document remains memory resident for the lifetime of the service.

To restrict memory consumption, the content files can be loaded in to memory 321 from storage 319 only as required by the service. When a binder is opened, the corresponding content XML file is parsed into a memory resident document which can then be read or modified. When the binder is closed the document is saved back to the corresponding XML content file.

A binder may be opened by multiple concurrent threads of execution within the metabase service. While a specific binder may be opened for reading by multiple threads, it may only be opened for modification by a single thread. A second thread attempting to open the binder for modification will be blocked until the first thread has closed the binder.

To reduce latency, a temporal cache 321 can retain the memory resident content documents for the most recently opened binders. When a binder is first opened, the corresponding content document can be added to the cache 321.

A document is removed from the cache typically when:
A. The corresponding binder has been closed by all accessing threads.
B. The cache is full and the document is the oldest document resident in the cache.
   Full-Text Catalogs

A full-text index stores information about significant words and their location within a given binder in full-text catalog file 327. This information is used to quickly complete full-text queries that search for binders containing particular words or combinations of words.

The full-text index is not stored within the metabase. The index is managed by a separate indexing service 301 usually provided by the operating system, not shown, that is hosting the metabase.

Whenever a binder 203 is created or changed, the metabase issues a request to the indexing service over an appropriate bus illustrated as 323. The indexing engine then invokes a metabase content filter 325 for the specified binder.

The content filter 325 is a content filter that contains logic that extracts the significant text from each of the label, track, media and store elements contained within the binder.
For each label 211, only parameter elements which contain textual values (i.e. type=“String”) are considered significant. Furthermore, child elements that define constraints on the parameter value are ignored.
For each track 213, only segment elements that contain textual values are considered significant. Additionally, all child parameter elements can be ignored because they describe the analysis of a media asset, not the asset itself.
Media elements 215 can be ignored entirely because they inherently refer to files which primarily contain binary data and any textual metadata has presumably been embodied in a label or track element.
Because store elements 217 contain data produced by other applications, the metabase filter 321 generally cannot process them directly. Rather, the metabase defers the extraction to a filter associated with the application or data type if one is available.
   Search

A metabase search, when issued, causes examination of each binder within a given scope. The scope may include the entire directory tree, a specific branch or a single folder. Each binder that matches a specific set of criteria is included in the search results.

The examination of a binder 203 involves two tests:
The first test determines if the attributes of the binder match a specific set of criteria. The criteria may include the binder name, creation date, modification date, etc. If the binder matches all of the criteria the second test is applied.
The second test evaluates the content of the binder using a specific predicate expression. A predicate expression evaluates to a Boolean value (true or false). If the predicate evaluates to true the binder is included in the set of search results.

The metabase supports two types of predicate expressions: full-text and XPath.

A full-text predicate specifies one or more text matching terms. Multiple terms may be combined using logical or proximity conditions, for example:
CONTAINS ‘dog’ AND ‘cat’ NEAR ‘pets’

Full-text predicates are passed to the indexing service 301 for evaluation.

An XPath predicate can be used to test any combination of element and attributes values within the binder content, for example:
label[@name=‘MyLabel.xml’]/parameter[@name=‘Genre’]/text()=‘Sports’
or,
track[@name=‘Captions.xml’]/segment[contains(text(),‘Story’)]
   File Server Emulation

The metabase implements several protocols that provide network access to the contained metadata.

One such implementation uses HyperText Transfer Protocol (HTTP RFC2616) and HTTP Extensions for Distributed Authoring (DAV RFC2518) to present the metabase as a conventional file system. This allows a client application to access both the essence and metadata for a media asset without specific knowledge of the metabase structure or physical location of the essence data.

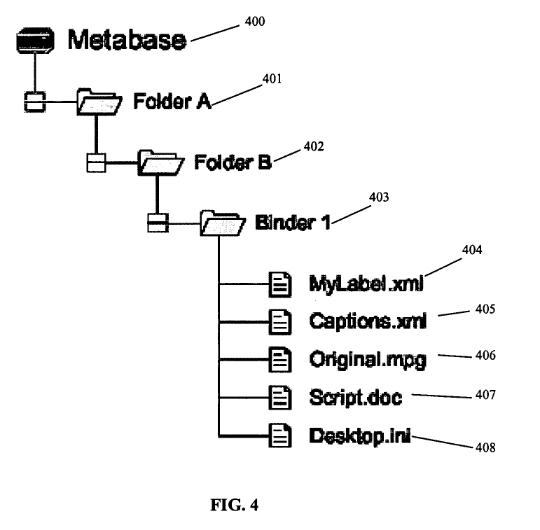

Turning now to FIG. 4, for the purpose of emulation, organizational elements within the metabase 400 (both folders such as 401, 402 and binders such as 403) are presented as collections or folders as seen in the figure. The content elements (labels, tracks, media and stores previously explained) are presented as members or files such as 404, 405, 406, 407 and 408. Each node within the emulated file system is then addressed by its fully qualified location, for example:
http://Metabase/Folder A/Folder B/Binder 1/MyLabel.xml

The implementation of HTTP and DAV protocols allows a client application to:
Retrieve a hierarchical membership listing (like a directory listing in a file system)
Delete or create a new folder 401 within the hierarchy corresponding to metabase folder 201.
Create, read or write to a content file such as 404-408 corresponding to metabase content objects 211 213 215 217.
Create, remove or query information about a file or folder such as the size, content type or modification date
Add or remove a lock that prevents multiple clients from modifying a binder at the same time

During a read operation, content elements are returned as follows:
For a label 211 or track 213, the entire XML representation of the element is returned as a byte stream using the appropriate character encoding.
For a media element 215, the data contained in the associated media file is returned as a byte stream.
For an internal store, the data contained within the store element 217 is returned as a byte stream.
For an external store, the data contained in the external file is returned as a byte stream.

While the foregoing has been with reference to particular embodiments of the invention, it will be appreciated by those skilled in the art that changes in these embodiments may be made without departing from the principles and spirit of the invention.

1. An XML metabase including a group of organizational objects, rules and content stored in physical storage as a collection of node objects organized in a hierarchical structure emanating from a single root node comprising:
A folder for organizing media assets, said media assets distributed across multiple devices and storage systems, and the metadata describing said media assets, said folder capable of hierarchical organization comprising a parent folder having child folders, each child folder having a unique name within the scope of its parent folder, said folder stored at a storage location described by said folder's fully qualified path in within said hierarchy; and
A binder within one of said folders, said binder representing a media asset and containing all of the metadata related to said media asset, and also storing the locations of all known media essence renditions distributed across multiple devices and storage systems, said binder having a unique name within the scope of its parent folder, said binder stored at a storage location described by said binder's fully qualified path within said hierarchy.

2. The XML metabase of claim 1 wherein said binder contains one or more content objects each describing a different aspect of said media asset, each content object having a name that is unique within the scope of its parent binder.

3. The XML metabase of claim 2 wherein said content objects comprise:
a label object containing structured metadata describing the entire media asset;
a track object containing structured metadata occurring specific points or during specific intervals within said media asset;
a media object describing a specific rendition of the media essence; and
a store object containing unstructured data associated with said media asset and produced by other applications outside said XML metabase.

4. The XML metabase of claim 3 including a behavioral object applied to a node of said XML metabase and specifying the rules according to which said node operates.

5. The XML metabase of claim 4 wherein said behavioral objects include at least one of:
an access rule determining the permissions granted to a user or groups of users of the metabase;
a schema rule determining the label and track metadata templates that are automatically added to a binder;
a rendition rule determining additional versions of said media essence required by other systems, applications or devices;
a storage rule assigning pools of physical storage space to a specific folder; and
an expiration rule controlling how long a media asset remains within the metabase and the disposition of each rendition when the media asset expires.
